(19) United States
(12) Patent Application Publication
(10) Pub. No.: US 2008/0275960 A1
(43) Pub. Date: Nov. 6, 2008

(54) Coordination and Management of Content Distribution

(75) Inventors: Tomi Myllyla, Espoo (FI); David J. Murphy, Helsinki (FI); Antti Sorvari, Itasalmi (FI); Joonas Paalasmaa, Helsinki (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 11/743,980

(22) Filed: May 3, 2007

(51) Int. Cl. G06F 15/16

(52) U.S. Cl. 709/217

(57) ABSTRACT

Content items may be transmitted and synchronized between a receiving device and a content hosting service (e.g., a file sharing service) using a coordinating device. The coordinating device may be in and/or connected to a local network of the local device and may facilitate communications between the local device and the remote service. Alternatively, the coordinating device may be remotely connected to the local device. The coordinating device may monitor for new content information on either the local device or the remote service (or both) and propagate new or updated content as appropriate. The coordinating device may further perform functions such as reformatting content, maintaining a database of content identifiers and synchronizing metadata associated with content items.

### BACKGROUND

Internet content is often unavailable on consumer electronics without a dedicated device to facilitate the reception and rendering of downloaded content. For example, many people use Internet content hosting sites to store pictures, video, audio and the like. However, they are usually only able to share and view that content on a personal computer unless they purchase and install a dedicated device that provides downloading and rendering of the content on a consumer electronic device such as a television. Such dedicated devices are often expensive, difficult to set up and limited in functionality. In one example, dedicated devices often do not provide appropriate monitoring, synchronization and updating of content, allowing downloaded content to become outdated and stale. In another example, the dedicated devices may require complex programming to achieve the desired results.

In view of the foregoing, methods and systems for managing, synchronizing and distributing content are needed.

### SUMMARY

According to one or more aspects, a method and system for coordinating the distribution of content may include a coordinating device that monitors a content service or provider for new content. Upon detection of new content, the coordinating device may propagate the new content or information associated with the new content to a receiving device. The receiving device may include a personal video recorder (PVR), a personal computer (PC) or other device that may store and/or render content for display on a consumer electronic device such as a television. Similarly, new or updated content on a device in the local network may be propagated to one or more content services. For example, if a new picture is placed in a folder of the local network, a coordinating device may detect the addition of the new picture and upload the picture of a shared album on an image hosting/sharing service. In one or more arrangements, the coordinating device may further be used to update and synchronize metadata of content items across various devices.

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates a mobile terminal on which one or more aspects described herein may be implemented.

FIG. 2 illustrates a network environment in which one or more aspects described herein may be implemented.

FIG. 3 is a flowchart illustrating a method for downloading content using a coordinating device according to one or more aspects described herein.

FIG. 4 is a flowchart illustrating a method for propagating content to a content hosting service through a coordinating device according to one or more aspects described herein.

FIG. 5 is a flowchart illustrating a method for synchronizing metadata according to one or more aspects described herein.

FIG. 6 is a flowchart illustrating a method for reformatting a content item according to one or more aspects described herein.

FIG. 7 illustrates a system for coordinating the distribution of content according to one or more aspects described herein.

### DETAILED DESCRIPTION

In the following description of various illustrative embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

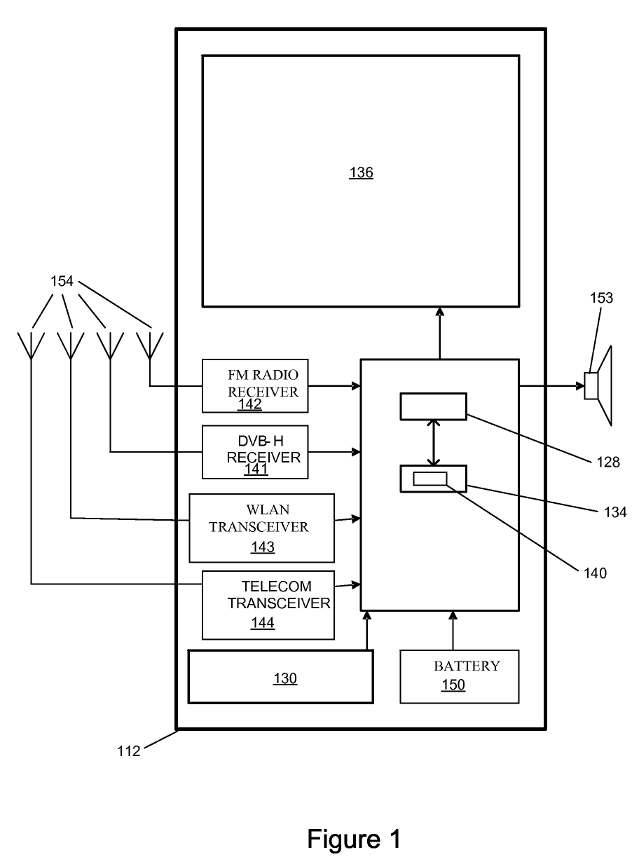

FIG. 1 illustrates a block diagram of a terminal including processor 128 connected to user interface 130, memory 134 and/or other storage, and display 136. Mobile terminal 112 may also include battery 150, speaker(s) 153 and antennas 154. User interface 130 may further include a keypad, touch screen, voice interface, one or more arrow keys, joy-stick, data glove, mouse, roller ball, touch screen, or the like. Mobile terminal 112 may comprise a computer, personal data assistant (PDA), mobile telephone and the like.

Computer executable instructions and data used by processor 128 and other components within mobile terminal 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile terminal 112 to perform various functions. Alternatively, some or all of mobile device 112 computer executable instructions may be embodied in hardware or firmware (not shown).

Mobile terminal 112 may be configured to receive, decode and process digital broadband broadcast transmissions that are based, for example, on the DVB standard, through a specific DVB receiver 141. The mobile device may also be provided with other types of receivers for digital broadband broadcast transmissions. Additionally, mobile terminal 112 may also be configured to receive, decode and process transmissions through FM/AM Radio receiver 142, WLAN transceiver 143, and telecommunications transceiver 144. Transceivers 143 and 144 may, alternatively, be separated into individual transmitter and receiver components (not shown). In one aspect of the invention, mobile terminal 112 may receive Radio Data System (RDS) messages. Other transmission and reception systems may also be used including Bluetooth transceivers. In one or more instances, signals may be transmitted to and received from another mobile terminal (not shown). For example, audio, video and other signals may be transmitted between two terminals using various transmission protocols such as wireless local area networks (WLANs), General Packet Radio Service (GPRS), third generation mobile system technology (3G), Bluetooth and/or Universal Plug and Play (UPnP). Such networks may be used to access or support local networks or remote networks such as the Internet.

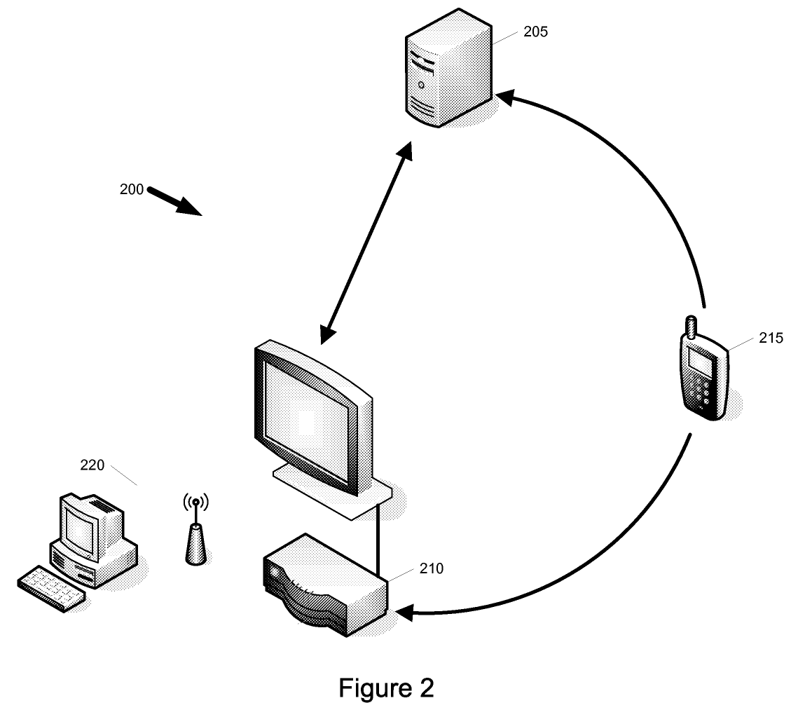

FIG. 2 illustrates a block diagram of a network environment in which the aspects described herein may be implemented. Network environment 200 may include multiple computing devices such as content server 205, media device 210 and coordinating device 215. Media device 210 may include a media server, a personal video recorder (PVR) and/or a personal computer (PC). Coordinating device 215 may include a mobile communication device (e.g., a cellular telephone or smartphone), a personal digital assistant (PDA), a portable computing device and the like. Each of devices 205, 210 and 215 may be connected to one another through a network. In one or more arrangements, coordinating device 215 may be connected to media device 210 through a local network using a peer-to-peer network connection (e.g., using UPnP protocols). Coordinating device 215 may connect to the local network through a variety of methods including various tunneling techniques. Concurrently, coordinating device 215 may also be connected to content server 205 through a wired or wireless wide area network connection (e.g., an Internet connection using GPRS or WLAN). Devices 205, 210 and 215 may be connected directly or may be connected through one or more intermediate devices such as a network access point (e.g., local or home network access point 220), router, gateway and the like.

Content server 205 may include file sharing services, content hosting services, content providers and the like. File sharing services may allow users to distribute various types of contents like music, photos, videos and audio to other users using the service (e.g., peer-to-peer distribution services) while content hosting services may provide storage space for a user's library of content. Examples of content hosting services include FLICKR, IMEEM, GOOGLE VIDEO, YOUTUBE and VIZREA. For content hosting services, a user may control access rights to the content or content may be public. As such, a user may specify the extent to which his or her content may be distributed. In contrast to file sharing and content hosting services, content providers may originate and distribute content such as television programs, music, radio, movies, video games and the like upon request (and often purchase) of a user.

Coordinating device 215 and media device 210 may be parts of a local or home network. In one or more configurations, coordinating device 215 may be connected to a local or home network using tunneling techniques. Each of devices 215 and 210 may further be UPnP enabled for connecting to and communicating through the local or home network. In one example, coordinating device 215 may transmit content to media device 210 for subsequent playback or display using UPnP transmission protocols. Alternatively or additionally, coordinating device 215 may transmit a uniform resource identifier (URI) to media device 210. Media device 210 may then retrieve the content from the specified URI for playback or rendering. Additionally, media device 210 may upload information to a network (e.g., to content server 205) through coordinating device 215 or through an independent connection. Coordinating device 215 may serve as a mediator or facilitator that coordinates the transmission of information to and from devices in a local network. In one or more configurations, a local home network may include a content storage device for storing a coordinating device user's personal content since coordinating devices like mobile telephones often have limited storage capacity. Thus, content downloaded to or otherwise available on a user's coordinating device (e.g., device 215) may be manually or automatically transmitted to a local home network for storage. Further, information associated with content such as metadata tags may be updated in a similar fashion. Alternatively or additionally, device 215 may be used to coordinate the propagation of information to and from a device (not shown) not on a local network to which device 215 is connected.

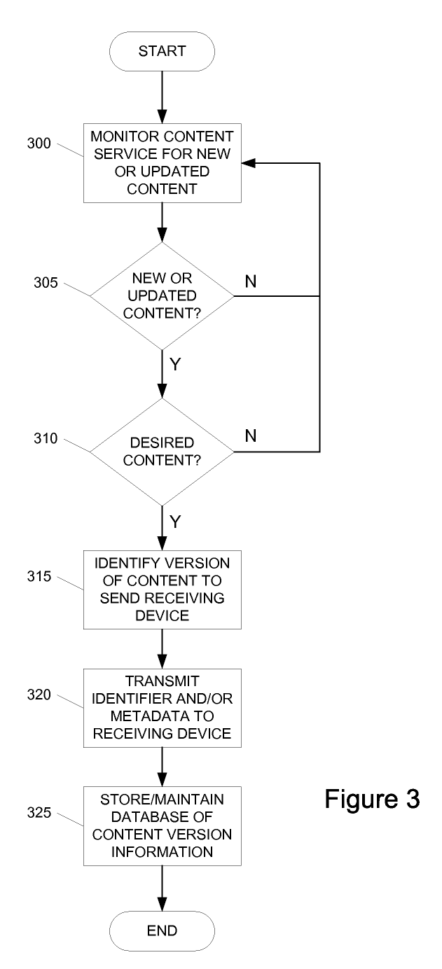

FIG. 3 is a flowchart illustrating a method for obtaining content from a content server using a coordinating device. A coordinating device, as used herein, generally refers to a device that facilitates the transfer of content between two or more devices. A coordinating device may include multimedia computing devices such as cellular telephones, PCs, PDAs and the like. In step 300, a coordinating device may monitor content services for new or updated content by querying the services for new or updated content. New content, as used herein, may refer to either content that was not previously available or previously available content that has been updated. Querying may involve subscribing to a web or content feed (e.g., RSS, Atom) that notifies the coordinating device of updates or changes as they occur. For example, updates to RSS feeds may be issued when content has been added, updated or otherwise changed. Alternatively or additionally, querying content services for new or updated content may include requesting content information from a content service and comparing the information to locally stored data to determine if any information has changed. Content information may include content items and/or information associated with content items such as metadata. According to one or more aspects, changes may be detected by comparing metadata associated with a content item. Metadata may include author information, title information, size data, date modified information and the like. Accordingly, by comparing metadata received from a content service with currently stored metadata, a determination may be made as to whether a content item has been updated or changed.

In step 305, the coordinating device may determine whether new or updated content exists on the content service. The determination may be made according to the methods described. In step 310, the coordinating device may determine whether the new or modified content is desired by a user. In one example, the coordinating device may compare predefined criteria with metadata (e.g., author, genre, era) and/or other information associated with the one or more new or modified content items. If the coordinating device determines that new or modified content exists and that a user would be interested in the content, the coordinating device may identify a version of content to send to a local or home device based on specified preferences in step 315. For example, if the local device has low storage capacity, the local device may request low quality versions of content. In another example, if the local device only supports up to a certain resolution, the local device may request and retrieve content versions that do not exceed the device's display or rendering capabilities. Accordingly, in step 320, the coordinating device may forward a URI and/or metadata to the local device on the local network in accordance with one or more specified preferences. If no preferences are indicated or set or if only one version exists, the coordinating device may forward the URI and/or metadata associated with the content without making the determination of step 315.

In transmitting the URI to the local device, the coordinating device may or may not provide instructions to the device to download the content. In one example, the coordinating device may allow the local device to independently determine whether to download the content based on information available to the local device (e.g., network congestion, download priority). In another example, the coordinating device might not instruct the local device to download the content to conserve storage space until (or shortly before) the content is needed. Thus, if a user schedules viewing of a particular program or content item ahead of time, the local device may retrieve the content sufficiently prior to the scheduled viewing time so that the content may be viewed without interruption. Interruptions may occur due to content buffering (e.g., for streaming downloads) or network problems.

Additionally or alternatively, in one or more instances where the local device does not have network access to the content service, the coordinating device may act as an access point for downloading the content to the local device. The coordinating device may facilitate the download in a variety of ways including fully downloading the content item to the coordinating device before sending the content to the local device or facilitating a streaming download (e.g., if the content item is too large to be fully downloaded to the coordinate device).

Once the content and/or the URI thereof has been transmitted to the local device, the coordinating device may store and maintain a database to associate or link the various versions of a content item together in step 325. Using such a method may allow a user to obtain a different version of a content item if he or she is dissatisfied with a current version without having to conduct extensive searches for a different and/or desired version.

In one or more configurations, the local device may directly retrieve a content item from a content source using a provided URI. The metadata associated with the content item, however, may be propagated to the local device from the coordinating device and subsequently associated with the received content. A coordinating device may use various protocols for uploading the metadata to the local device including UPnP control point application programming interface (API) (e.g., UpdateObject functionality). Such configurations may be used in the event metadata cannot be pulled, by the local device, from web or content feeds or other non-UPnP compatible sources.

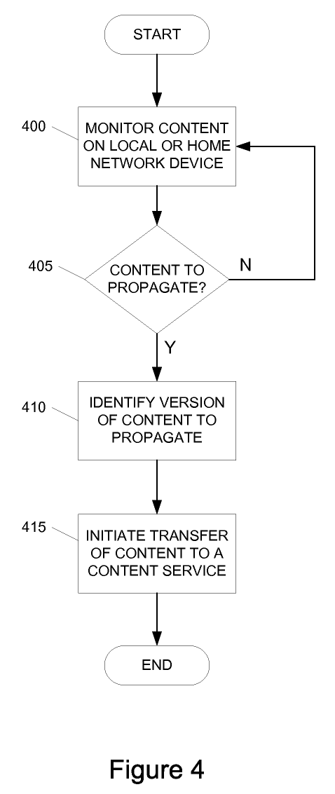

Additionally, a coordinating device may also serve as a coordinator for automatically uploading content based on one or more specified criteria. FIG. 4, for example, is a flowchart illustrating a method for uploading content to a content service based on specified criteria. In step 400, a coordinating device may monitor content stored on a second device on a local or home network. For example, the coordinating device may periodically (or based on some other schedule) retrieve content information (e.g., author, title, last time and/or date modified, size, share status) from the second device. Using this information, the coordinating device may determine in step 405 whether one or more content items should be propagated to a content service. In one example, the coordinating device may determine whether new or updated content items have been added with a shared flag or to a shared folder. In another example, a user may specify that all content items authored by a particular individual should be uploaded to the content service. One of ordinary skill will appreciate that a variety of factors and decision making algorithms may be implemented to decide what content items, if any, to propagate to a content service.

If new or updated content items are identified, the coordinating device may further identify particular versions of the new or updated content items to upload in step 410. Users may specify, for example, that only reduced-size versions of content be uploaded. Accordingly, the coordinating device may identify the appropriate version based on user preferences and/or other factors. According to one or more aspects, if a specified upload version of the content is not available, either the second device or the coordinating device may create the specified upload version (e.g., reduced-size version) prior to transmission to the content service. An upload version, as used herein, generally relates to a version of content designated for upload or transmission to another device. The coordinating device may then upload or provide instructions for uploading the new and/or updated items to a content service in step 415. Uploading may be performed in various manners. In one or more arrangements, the coordinating device may instruct the second device to upload the identified content items to a specified content service. In particular, the coordinating device may provide a URI of the content service to the second device. Additionally, the second device may create the upload version if one is not already available. Alternatively, the coordinating device may request and retrieve the identified content items from the second device and upload the content to a content service. In these alternative instances, the coordinating device may be responsible for creating the upload version if the version is not already available.

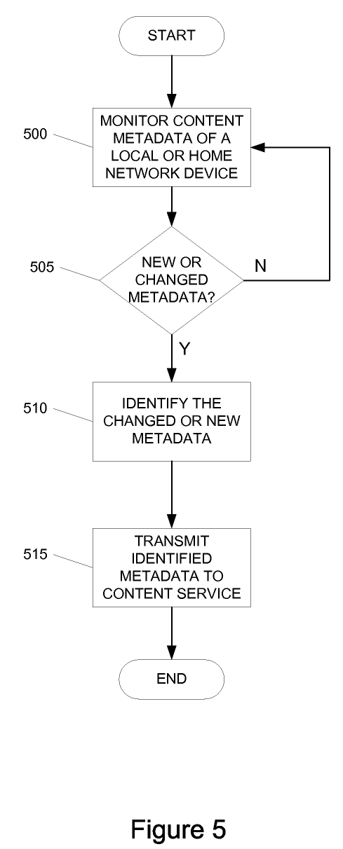

In addition to propagation of new or updated content items, a coordinating device may further update and propagate metadata associated with content items. FIG. 5 is a flowchart illustrating a method for propagating new or updated metadata associated with a content item to a content service. In step 500, a coordinating device connected to a local network may monitor metadata tags for content stored in one or more second devices in the local network. For example, the coordinating device may periodically request metadata information from the one or more second devices and compare the information to metadata stored by the coordinating device. Alternatively or additionally, the coordinating device may request metadata information from the one or more second devices when activity is detected within the local network. Other factors or events may be used as triggers for requesting and evaluating metadata from second devices in the network.

In step 505, the coordinating device may determine whether metadata tags associated with one or more content items have been added, changed or otherwise modified. The determination may be performed by comparing the retrieved metadata with the metadata currently stored in a database of the coordinating device. The new or modified metadata may thus be identified in step 510 based on the determination of step 505. The new and/or modified metadata may then be propagated/uploaded to various content services in step 515. Content services may be automatically selected by the coordinating device based on known available services or may be pre-selected by a user based on preferences and/or other factors. In one or more configurations, a coordinating device such as a mobile telephone may be manufactured with predefined content sharing services. Alternatively or additionally, a content service may be selected if the content service already has metadata corresponding to the content item to be uploaded.

According to one or more arrangements, a second device in the local network may support various metadata harvesting protocols such as International Press Telecommunications Council (IPTC) metadata harvesting. Thus, in one example, metadata changes made to IPTC tags using a content management application may be imported (automatically or manually) to a second device such as a media server. The metadata may then be automatically propagated to various content services through a coordinating device according to the method described in FIG. 5. Alternatively or additionally, harvesting may not be needed in instances where the content management application directly interacts with the metadata stored in the media server or other second device. Further, changes made to metadata locally may be directly propagated to the content service such that metadata harvesting is not needed or used. In one example, a coordinating device may periodically or aperiodically retrieve content header information, e.g., IPTC/Exchangeable Image File Format (EXIF) tags, from a media device on the local network using HTTP requests and/or UPnP control point API. In one or more configurations, only the header information of the content files may be retrieved to determine if any metadata has changed. Thus, a file transfer may be interrupted as soon as header information has been received.

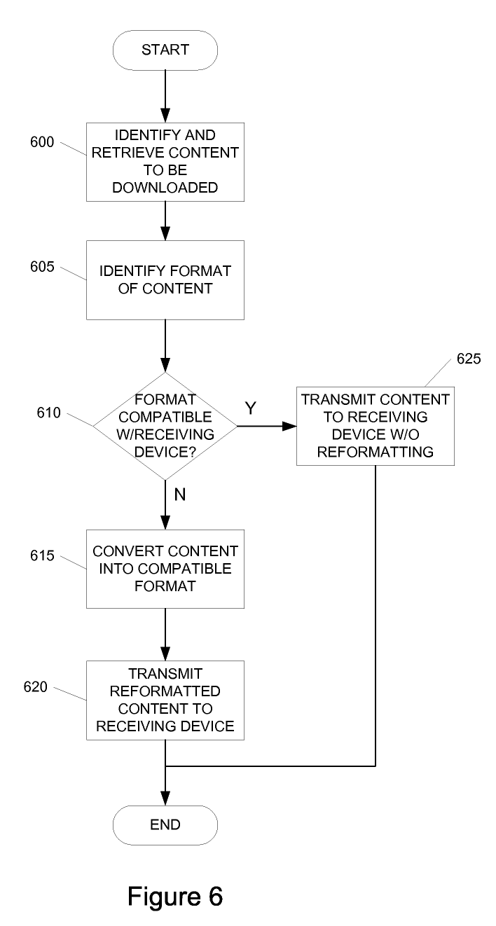

In some instances, content to be propagated to a local device might not be in a compatible format. For example, a local device may only have a PDF viewer while the content is formatted as a MICROSOFT WORD document. FIG. 6 is a flowchart illustrating a method for converting content to a compatible format. In step 600, a coordinating device may identify and retrieve content to be downloaded or propagated to a second device on the local network. In step 605, the coordinating device may determine a format associated with the content. In step 610, the coordinating device may then determine whether the content format is compatible with or understandable by the second device. The coordinating device may make such a determination based on capability information obtained from the second device. If the content format is incompatible with the second device, the coordinating device may convert the content into a second format compatible with the second device in step 615. Once converted, the content may be transmitted to the second device in step 620. If, on the other hand, the content format is compatible with the second device, the content (in the original format) may be downloaded to the second device in step 625.

The above methods for converting content from a first format to a second format may similarly be used for content being propagated from a local content store to a content service. Accordingly, a coordinating device may reformat an image for an image hosting site that only allows JPEGs and GIF formatted images if the image is in some other format.

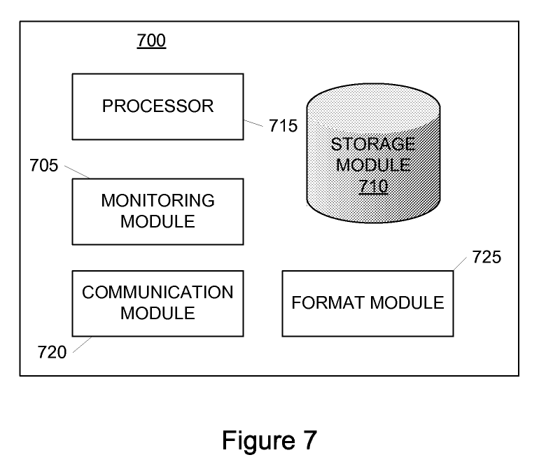

FIG. 7 is a block diagram illustrating one or more modules of a system for coordinating the updating and synchronization of content. System 700 may include monitoring module 705, storage module 710, processing module 715, communication module 720 and format module 725. Monitoring module 705 may be configured to periodically, or based on some other schedule, determine content items stored on a second device (e.g., a local media device or a remote content service). Monitoring module 705 may transmit content information to processing module 715 so that system 700 may determine whether new or updated content items are available. Processing module 715 may, for example, compare the content information with previously stored content information to determine if any changes have occurred. Content information received may be stored by storage module 710. Storage module 710 may further store associations between various content information such as between multiple versions of the same content item. Storage module 710 may also store logs or records of content transmissions and receptions. Format module 725 may be used by system 700 to convert content form one format to another. Format module 725 may be used when the destination or receiving device does not have the capability to view or understand a content item in the content item's native format. Communications with other devices may be facilitated through communication module 720 which may determine proper protocols to use and convert communications to conform to those protocols.

As discussed, the coordinating device may include various types of computing devices including mobile telephones, PDAs and PCs. As such, the systems and methods described herein may be implemented through an application running on a PC. The PC may utilize UPnP functionality to communicate with media servers in the local network while using a wide area network connection (e.g., Internet connection) to communicate with one or more content services. The PC may also utilize content service APIs for various functions. Still further, the PC application may subscribe to web or content feeds such as RSS or Atom feeds for enabling automatic content pull/push between the local network and the content services.

While many aspects have been described with respect to propagating new or modified content in a second device of a local network or a content service, the methods and systems may also be used to propagate information from the coordinating device. For example, the coordinating device may maintain a database of content items and/or associated metadata corresponding to content and metadata stored by a content service and/or a second device. If a change is made to content and/or metadata thereof on the coordinating device, the changes may be propagated to either or both of the content service and the second device to insure synchronization of content and metadata. Additionally or alternatively, the coordinating device and the receiving device (e.g., the second device) might not be on the same local network. For example, the coordinating device may propagate content information to or from the second or receiving device through the Internet.

Further, a coordinating device may also maintain a database of URIs to content and metadata thereof associated with content that is downloaded to a second device or uploaded to a content service. By storing the content URIs and/or metadata, the coordinating device and/or a user thereof may share the content with others without having to share the actual content. Instead, the other users may use the URI to retrieve the shared content.

Additionally, the methods and features recited herein may further be implemented through any number of computer readable media that are able to store computer readable instructions. Examples of computer readable media that may be used include RAM, ROM, EEPROM, flash memory or other memory technology, CD-ROM, DVD or other optical disk storage, magnetic cassettes, magnetic tape, magnetic storage and the like.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

We claim:

1. A method comprising:
monitoring, at a coordinating device, content offered by one or more content services;
determining, at the coordinating device, whether the offered content includes new content information; and
in response to determining that the offered content includes the new content information, transmitting the new content information to a receiving device.

2. The method of claim 1, wherein the receiving device is on a local network to which the coordinating device is connected.

3. The method of claim 1, wherein the new content information comprises new or updated metadata associated with a content item.

4. The method of claim 1, wherein the new content information comprises a new content item.

5. The method of claim 4, wherein monitoring, at the coordinating device, content offered by one or more content services includes subscribing to a web feed configured to provide notifications of new content.

6. The method of claim 4, wherein determining, at the coordinating device, whether the offered content includes new content information includes comparing first metadata associated with the new content item with second metadata associated with content items available on the receiving device.

7. The method of claim 6, wherein the first metadata includes at least one of: author information, size data, genre information and version information.

8. The method of claim 4 further comprising storing, in the coordinating device, one or more links between a plurality of versions of the new content item.

9. The method of claim 4, wherein transmitting the new content information to the receiving device comprises transmitting the new content item to the receiving device.

10. The method of claim 4 wherein transmitting the new content information to the receiving device comprises transmitting metadata associated with the new content item to the receiving device.

11. The method of claim 4 further comprising determining, at the coordinating device, whether a user of the receiving device is interested in the new content item based on specified criteria.

12. The method of claim 1, wherein transmitting the new content information to the receiving device comprises transmitting a source identifier to the receiving device, the source identifier configured to direct the receiving device to a location providing the new content information.

13. A method comprising:
monitoring, at a coordinating device, a content storage of a media device;
determining, at the coordinating device, whether the content storage includes new content information; and
in response to determining that the content storage includes the new content information, initiating a transmission of the new content information to a content hosting service.

14. The method of claim 13, wherein the media device is located on a local network to which the coordinating device is connected and wherein the content hosting service is not on the local network.

15. The method of claim 13, wherein the coordinating device comprises at least one of: a mobile communication device, a personal computer and personal digital assistant (PDA).

16. The method of claim 13, wherein determining, at the coordinating device, whether the content storage includes new content information comprises determining whether the new content information is flagged for transmitting to the content hosting service.

17. The method of claim 13, wherein initiating a transmission of the new content information to a content hosting service comprises transmitting instructions to the media device to transmit the new content information to the content hosting service.

18. The method of claim 13, wherein initiating a transmission of the new content information to a content hosting service comprises:
retrieving, at the coordinating device, the new content information from the media device; and
transmitting the new content information to the content hosting service from the coordinating device.

19. The method of claim 13, wherein the media device and the coordinating device communicate using a peer-to-peer networking protocol.

20. The method of claim 13, wherein the new content information comprises at least one of: new metadata and a new content item.

21. A computer readable medium storing computer readable instructions that, when executed, cause a processor to perform a method comprising:
monitoring content offered by one or more content services;
determining whether the offered content includes new content information; and
in response to determining that the offered content includes the new content information, transmitting the new content information to a receiving device.

22. The computer readable medium of claim 21, wherein monitoring content offered by one or more content services includes subscribing to a web feed configured to provide notifications of new content.

23. The computer readable medium of claim 21, wherein determining whether the offered content includes new content information includes comparing first metadata associated with the new content information with second metadata associated with content items available on the receiving device.

24. A computer readable medium storing computer readable instructions that, when executed, cause a processor to perform a method comprising:
monitoring, at a coordinating device, a content storage of a media device;
determining, at the coordinating device, whether the content storage includes new content information; and
in response to determining that the content storage includes the new content information, initiating a transmission of the new content information to a content hosting service.

25. The computer readable medium of claim 24, wherein determining whether the content storage includes new content information comprises determining whether the new content information is flagged for transmitting to the content hosting service.

26. The computer readable medium of claim 24, wherein initiating a transmission of the new content information to a content hosting service comprises transmitting instructions to the media device to transmit the new content information to the content hosting service.

27. The computer readable medium of claim 24, wherein initiating a transmission of the new content information to a content hosting service comprises:
retrieving the new content information from the media device; and
transmitting the new content information to the content hosting service.

28. A system comprising:
a coordinating device including:
a monitoring module configured to monitor content offered by one or more content services;
a processor configured to determine whether the offered content includes a new content information; and
a communication module configured to transmit content information associated with the new content information to a receiving device in response to determining that the offered content includes the new content information.

29. The system of claim 28, further comprising a format module configured to convert the new content information from a first format to a second format, wherein the new content information includes a new content item.

30. The system of claim 28, wherein the receiving device is on a local network to which the coordinating device is connected.

31. A system comprising:
a coordinating device including:
a monitoring module configured to monitor a content storage;
a processor configured to determine whether the content storage includes new content information; and
a communication module configured to initiate a transmission of the new content information to a content hosting service in response to determining that the content storage includes the new content information.

32. The system of claim 31, further comprising a format module configured to convert a new content item included in the new content information from a first format to a second format.

33. The system of claim 31, wherein the content storage is located on a local network to which the coordinating device is connected.
